(19) United States
(12) Patent Application Publication
(10) Pub. No.: US 2009/0102793 A1
(43) Pub. Date: Apr. 23, 2009

(54) OPTICAL MOUSE

(75) Inventors: David Bohn, Fort Collins, CO (US); Mark DePue, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/876,092

(22) Filed: Oct. 22, 2007

(51) Int. Cl. G06F 3/033

(52) U.S. Cl. 345/166

(57) ABSTRACT

An optical mouse configured to track motion on a broad range of surfaces is disclosed. In one embodiment, an optical mouse includes a light source configured to emit light having a wavelength in or near a blue region of a visible light spectrum, an image sensor positioned relative to the light source such that light from a specular portion of a distribution of light reflected by the tracking surface is detected by the image sensor, and a controller configured to receive image data from the image sensor and to identify a tracking feature in the image data.

### BACKGROUND

An optical computer mouse uses a light source and image sensor to detect mouse movement relative to an underlying tracking surface to allow a user to manipulate a location of a virtual pointer on a computing device display. Two general types of optical mouse architectures are in use today: oblique-LED architectures and laser architectures. Each of these architectures utilizes a light source to direct light onto an underlying tracking surface and an image sensor to acquire an image of the tracking surface. Movement is tracked by acquiring a series of images of the surface and tracking changes in the location(s) of one or more surface features identified in the images via a controller.

An oblique-LED optical mouse directs incoherent light from a light-emitting diode (LED) toward the tracking surface at an oblique, grazing angle, and light scattered off the tracking surface is detected by an image detector disposed at oblique angle to the reflected light. Contrast of the surface images is enhanced by shadows created by surface height variations, allowing tracking features on the surface to be distinguished.

In contrast, a laser optical mouse operates by directing a coherent beam of light, generally in the infrared or red wavelength regions, onto a tracking surface. Images of the tracking surface are detected at a specular or near-specular angle. Contrast of the surface image is achieved as a result of specular reflections due to low frequency surface variations. Some contrast may also arise from interference patterns in the reflected laser light.

While each of these architectures generally provides satisfactory performance on a range of surfaces, each also may display unsatisfactory performance on specific surface types and textures. For example, the oblique-LED optical mouse works well on rough surfaces, such as paper and manila envelopes, as there is an abundance of scattered light scattered from these surfaces that can be detected by the obliquely-positioned detector. However, the oblique-LED optical mouse may not work as well on shiny surfaces, such as whiteboard, glazed ceramic tile, marble, polished/painted metal, etc., as most of the grazing light is reflected off at a specular angle, and little light reaches the detector.

Likewise, the laser optical mouse may not perform as well on rough surfaces, especially fibrous surfaces such as white copier paper commonly found in an office environment. Because the laser interacts with paper fibers at different depths, the resulting navigation images may contain interference patterns that lead to image features with short correlation lengths, and may result in decorrelated poor mouse tracking.

### SUMMARY

Accordingly, embodiments of optical mice configured to track well on a broad suite of surfaces are described herein. In one disclosed embodiment, an optical mouse includes a light source configured to emit light having a wavelength in or near a blue region of a visible light spectrum toward a tracking surface, an image sensor positioned relative to the light source such that light from a specular portion of a distribution of light reflected by the tracking surface is detected by the image sensor, and a controller configured to receive image data from the image sensor and to identify a tracking feature in the image data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an optical mouse.

FIG. 2 shows an embodiment of an optical architecture for the optical mouse of FIG. 1.

FIG. 3 shows a graph illustrating an example of specular and diffuse components of a distribution of light reflected from a surface.

FIG. 4 illustrates the reflection and transmission of light incident on a transparent dielectric slab.

FIG. 5 shows a schematic model of a tracking surface as a collection of dielectric slabs.

FIG. 6 illustrates a penetration depth of beam of light incident on a metal surface.

FIG. 7 shows a graph of a comparison of a reflectivity of white paper with and without optical brightener.

FIG. 8 illustrates a simplified model of reflection for an incident beam of light reflecting off multiple layers of fibers in a sheet of paper.

FIG. 9 shows a schematic depiction of the correlation of an image across a laser mouse image detector as the mouse is moved across a white paper surface.

FIG. 10 shows a schematic depiction of the correlation of an image across a blue incoherent optical mouse image detector as the mouse is moved across a white paper surface.

FIG. 11 shows a process flow depicting a method of tracking motion of an optical mouse across a tracking surface.

### DETAILED DESCRIPTION

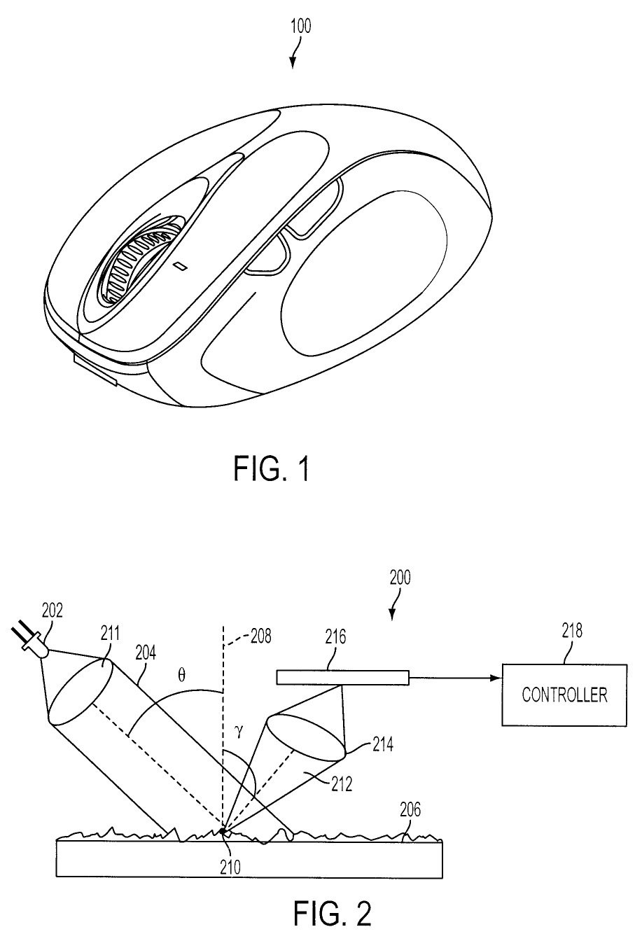

FIG. 1 shows an optical mouse 100, and FIG. 2 illustrates an embodiment of an optical architecture 200 for the optical mouse 100. The optical architecture 200 comprises a light source 202 configured to emit a beam of light 204 toward a tracking surface 206 such that the beam of light 204 is incident upon the tracking surface at a location 210. The beam of light 204 has an incident angle θ with respect to the normal 208 of the tracking surface 206. The optical architecture 200 may further comprise a collimating lens 211 disposed between the light source 202 and the tracking surface 206 for collimating the beam of light 204.

The light source 202 is configured to emit light in or near a blue region of the visible spectrum. The terms “in or near a blue region of the visible spectrum”, as well as “blue”, “blue light” and the like, as used herein describe light comprising one or more emission lines or bands in or near a blue region of a visible light spectrum, for example, in a range of 400-490 nm. These terms may also describe light within the near-UV to near-green range that is able to activate optical brighteners, as described in more detail below.

In various embodiments, the light source 202 may be configured to output incoherent light or coherent light, and may utilize one or more lasers, LEDs, OLEDs (organic light emitting devices), narrow bandwidth LEDs, or any other suitable light emitting device. Further, the light source 202 may be configured to emit light that is blue in appearance, or may be configured to emit light that has an appearance other than blue to an observer. For example, white LED light sources may utilize a blue LED die (composed of InGaN, for example) either in combination with LEDs of other colors, in combination with a scintillator or phosphor such as cerium-doped yttrium aluminum garnet, or in combination with other structures that emit other wavelengths of light, to produce light that appears white to a user. In yet another embodiment, the light source 202 comprises a generic broadband source in combination with a band pass filter that passes blue light. Such LEDs fall within the meaning of “blue light” as used herein due to the presence of blue wavelengths in the light emitted from these structures.

Continuing with FIG. 1, some portion of the incident beam of light 204 reflects from the tracking surface 206, as indicated at 212, in a distribution about a specular reflection angle γ, which equals the incident angle θ. Some of the reflected light 212 is imaged by a lens 214 onto an image sensor 216. As shown in FIG. 1, the image sensor 216 is positioned at a specular or near-specular angle so that it detects at least a portion of light within a specular portion of a distribution of the reflected light 212. As described below, the use of a blue light source in combination with an image detector positioned to detect reflected light at a specular angle may offer various advantages over other optical architectures.

The image sensor 216 is configured to provide image data to a controller 218. The controller 218 is configured to acquire a plurality of time-sequenced frames of image data from the image sensor 216, to process the image data to locate one or more tracking features in the plurality of time-sequenced images of the tracking surface, and to track changes in the location(s) of the plurality of time-sequenced images of the tracking surfaces to track motion of the optical mouse 100. The locating and tracking of surface features may be performed in any suitable manner, and is not described in further detail herein.

When configured to detect light in a specular portion of the reflected light distribution, the image sensor 216 may detect patches of specular reflection from a surface, which appear as bright patches on an image of a surface. In contrast, an obliquely-arranged detector is generally used to detect shadows, rather than patches of reflection, in an image of the tracking surface. Therefore, because more light reaches the image sensor 216 when the sensor is in a specular configuration than when the sensor is in an oblique configuration, the detection of an image in specularly reflected light may allow for shorter integration times and more accurate tracking during fast movement of the mouse 100. Shorter integration times also may allow the light source to be pulsed with less “on” time, thereby reducing the current drawn by the light source as a function of time and increasing battery life. Further, the use of a specular or near-specular image sensor configuration may also allow the use of a lower power light source, which also may help to increase battery lifetime.

Increasing the quantity of light that reaches the image sensor 216 may offer other advantages besides shorter integration times and lower power consumption. For example, the depth of field of an optical system is inversely proportional to the aperture of the system. Where a greater quantity of light reaches a detector per unit time, the aperture of the system may be decreased, thereby increasing the depth of field of the system and improving the imaging performance by reducing optical aberrations at the image. Therefore, the height of the tracking surface 206 relative to the image sensor 216 may have greater variation without loss of performance where the depth of field is greater. This may allow for looser manufacturing tolerances regarding the relative heights/positioning of the image sensor 216 and associated lenses 214 compared to the tolerances in the manufacturing of an oblique architecture system, and therefore may lead to lower manufacturing costs.

The incident beam of light 204 may be configured to have any suitable angle with the tracking surface 206. In some embodiments, the incident beam of light 204 may be configured to have a relatively steep angle with respect to the tracking surface normal. This may allow for looser manufacturing tolerances regarding the relative horizontal and vertical positioning of the light source 202 and/or image sensor in the mouse, as errors in positioning of these parts may not cause as great a degree of offset in the location 210 at which the light beam is centered on the tracking surface compared to the use of a shallower incident light angle (i.e. closer to parallel). Examples of suitable angles include, but are not limited to, angles in a range of 0 to 40 degrees relative to the tracking surface normal.

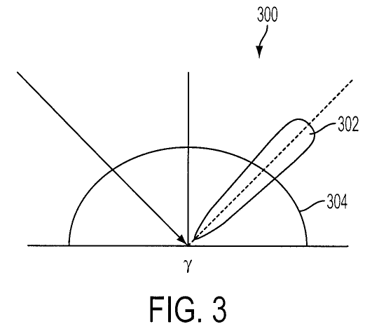

FIG. 3 shows an example of a plot of a distribution 300 of light reflected from a tracking surface. The distribution 300 comprises a specular distribution component 302 and a diffuse distribution component 304, which combined produce the distribution 300. The diffuse component arises from the scattering of light rays that enter the tracking surface and undergo multiple reflections and refractions. The specular component, in contrast, arises from the single reflection of incident light rays. The surface may be considered to be composed of a plurality of planar reflective elements, wherein each element has its own orientation. The resulting reflections are distributed around the specular direction, wherein the width of the specular component of the distribution is a function of surface roughness. The relative contributions of the specular distribution component 302 and the diffuse distribution component may vary depending upon the nature of the tracking surface, but generally the distribution 300 has a maximum light intensity at or near the specular reflection angle γ and lower intensity farther away from the specular reflection angle γ. In the case of a perfect mirror with no surface imperfections or absorption, 100% of the incident light is reflected at the specular angle. As shown in FIG. 3, the reflected light from common, non-mirror surfaces, such as paper, metal, and wood, has a higher intensity at or near the specular angle of reflection than at other points of the distribution. As used herein, the term “specular portion of the distribution of reflected light” may refer to the portion of the distribution of scattered light which lies within +/−20 degrees from the direction of the specular, mirror-like reflection (“specular axis”).

The image sensor 216 may be configured to detect light at any suitable angle relative to the specular reflection angle. Generally, the intensity of light may be highest at the specular reflection angle. However, other factors, such as a sensitivity of the image sensor, may favor placing the detector off the specular angle, but still within the specular portion of the distribution of reflected light. For an image sensor configured to detect motion on a broad range of surfaces ranging from metallic reflective surfaces to carpet and fabric surfaces, suitable detector angles include, but are not limited to, angles of 0 to +/−20 degrees from the specular angle.

As mentioned above, the use of a light source that emits light in or near a blue region of the visible spectrum may offer advantages over red and infrared light sources that are commonly used in LED and laser mice. These advantages may not have been appreciated due to other factors that may have led to the selection of red and infrared light sources over blue light sources, and therefore the benefits offered by the use of a blue light source may be unexpected. For example, currently available blue light sources may have higher rates of power consumption and higher costs than currently available red and infrared light sources, thereby leading away from the choice of blue light sources as a light source in an optical mouse.

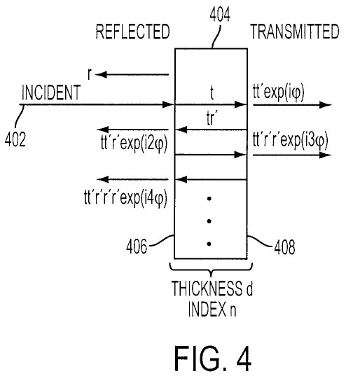

The advantages offered by blue light as defined herein arise at least partly from the nature of the physical interaction of blue light with reflective surfaces compared with red or infrared light. For example, blue light has a higher intensity of reflection from dielectric surfaces than red and infrared light. Referring to FIG. 4, this figure illustrates the reflection of an incident beam of light 402 from a dielectric slab 404 made of a material transparent to visible light, having a thickness d, and having a refractive index n. As illustrated, a portion of the incident beam of light 402 is reflected off a front face 406 of the slab, and a portion of the light is transmitted through the interior of the slab 404. The transmitted light encounters the back face 408 of the slab, where a portion of the light is transmitted through the back face 408 and a portion is reflected back toward the front face 406. Light incident on the front face is again partially reflected and partially transmitted, and so on.

The light in the beam of incident light 402 has a vacuum wavelength λ. The reflection coefficient or amplitude, as indicated by r, and the transmission coefficient or amplitude, as indicated by t, at the front face 406 of the slab 404 are as follows:

$$r = \frac{( 1 - n )}{( 1 + n )}$$

$$t = \frac{2}{( 1 + n )}$$

At the back face 408 of the slab, the corresponding reflection coefficient, as indicated by r′, and the transmission coefficient, as indicated by t′, are as follows:

$${r}^{′} = \frac{( 1 - n )}{( 1 + n )}$$

$${t}^{′} = \frac{2}{( 1 + n )}$$

Note that the reflection and transmission coefficients or amplitudes depend only upon the index of refraction of the slab 404. When the incident beam of light strikes the surface at an angle with respect to the surface normal, the amplitude equations are also functions of angle, according to the Fresnel Equations.

A phase shift φ induced by the index of refraction of the slab 404 being different from the air surrounding the slab 404 is provided as follows:

$$ϕ = \frac{2 π n d}{λ}$$

Taking into account the transmission phase shift and summing the amplitudes of all the partial reflections and transmissions yields the following expressions for the total reflection and transmission coefficients or amplitudes of the slab:

$$\begin{matrix}R = r + t {t}^{′} {r}^{′} exp ( i 2 ϕ ) {\sum }_{m = 0}^{∞} {[ {r}^{′} exp ( i ϕ ) ]}^{2 m} \\ = r + \frac{{r}^{′} t {t}^{′} exp ( i 2 ϕ )}{1 - {r}^{′2} exp ( i 2 ϕ )}\end{matrix}$$

$$\begin{matrix}T = t {t}^{′ } exp ( i ϕ ) {\sum }_{m = 0}^{∞} {[ {r}^{′} exp ( i ϕ ) ]}^{2 m} \\ = \frac{t {t}^{′} exp ( i 2 ϕ )}{1 - {r}^{′2} exp ( i 2 ϕ )}\end{matrix}$$

At the limit of a small slab thickness d, the reflected amplitude equation reduces to a simpler form:

$$R \approx i π d \frac{{n}^{2} - 1}{λ} exp [ \frac{i π ( {n}^{2} + 1 ) d}{λ} ]$$

At this limit, the reflected light field leads the incident light field by 90 degrees in phase and its amplitude is proportional to both 1/λ and the dielectric's polarizability coefficient (n²−1). The 1/λ dependence of the scattering amplitude represents that the intensity of the reflected light from a thin dielectric slab is proportional to 1/λ², as the intensity of reflected light is proportional to the square of the amplitude. Thus, the intensity of reflected light is higher for shorter wavelengths than for longer wavelengths of light.

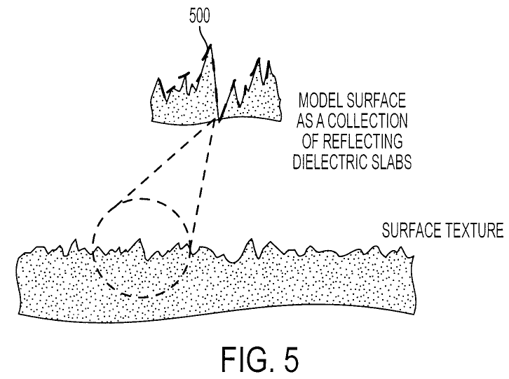

From the standpoint of an optical mouse, referring to FIG. 5, and as described above with reference to FIG. 3, the tracking surface may be modeled as comprising a large number of reflective elements in the form of dielectric slabs 500, each oriented according to the local height and slope of the surface. Each of these dielectric slabs reflect incident light; sometimes the reflected light is within the numerical aperture of the imaging lens, leading to a bright feature on the detector, and other times the light is not captured by the lens, leading to a dark feature at the detector. Operation in the blue at 470 nm leads to an enhancement of the intensity of reflected light in the bright features by an amount of 850²/470²≈3.3 over infrared light having a wavelength of 850 nm, and a factor of 630²/470²≈1.8 over red light having a wavelength of 630 nm. This leads to a contrast improvement in the blue light images at the detector, because bright features on the detector are brighter than they appear in corresponding red or infrared images. These higher contrast images enable the acceptable identification and more robust tracking of tracking features with lower light source intensities, and therefore may improve the tracking performance relative to infrared or red light mice, while also reducing the power consumption and increasing battery life.

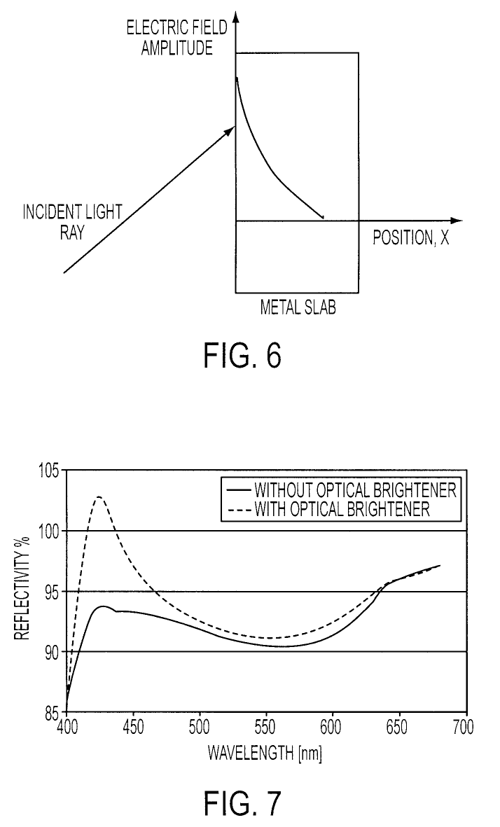

FIG. 6 illustrates another advantage of the use of blue light over red or infrared light in an optical mouse, in that the penetration depth of blue light is less than that of red or infrared light. Generally, the electric field of radiation incident on a surface penetrates the surface to an extent. FIG. 6 shows a simple illustration of the amplitude of an electric field within a metal slab as a function of depth. As illustrated, the electric field of the incident beam of light decays exponentially into the metal with a characteristic e-fold distance that is proportional to the wavelength. Given this wavelength dependency, infrared light may extend a factor of 1.8 times farther than blue light into a metal material. Short penetration depths also occur when blue light is incident upon non-metal, dielectric surfaces, as well; the exact penetration depth depends upon the material properties.

The lesser penetration depth of blue light compared to red and infrared light may be advantageous from the standpoint of optical navigation applications for several reasons. First, the image correlation methods used by the controller to follow tracking features may require images that are in one-to-one correspondence with the underlying navigation surface. Reflected light from different depths inside the surface can confuse the correlation calculation. Further, light that leaks into the material results in less reflected light reaching the image detector.

Additionally, the lesser penetration depth of blue light is desirable as it may lead to less crosstalk between adjacent and near-neighbor pixels and higher modulation transfer function (MTF) at the detector. To understand these effects, consider the difference between a long wavelength infrared photon and a short wavelength blue photon incident upon a silicon CMOS detector. The absorption of a photon in a semiconductor is wavelength dependent. The absorption is high for short wavelength light, but decreases for long wavelengths as the band-gap energy is approached. With less absorption, long wavelength photons travel farther within the semiconductor, and the corresponding electric charge generated inside the material must travel farther to be collected than the corresponding charge produced by the short wavelength blue photon. With the larger travel distance, charge carriers from the long wavelength light are able to diffuse and spread-out within the material more than the blue photons. Thus, charge generated within one pixel may induce a spurious signal in a neighboring pixel, resulting in crosstalk and an MTF reduction in the electro-optical system.

As yet another advantage to the use of blue light over other light sources, blue light is able to resolve smaller tracking features than infrared or red light. Generally, the smallest feature an optical imaging system is capable of resolving is limited by diffraction. Rayleigh's criteria states that the size d of a surface feature that can be distinguished from an adjacent object of the same size is given by the relationship

$$d \geq \frac{λ}{N A} ,$$

where λ is the wavelength of the incident light and NA is the numerical aperture of the imaging system. The proportionality between d and A indicates that smaller surface features are resolvable with blue light than with light of longer wavelengths. For example, a blue mouse operating at λ=470 nm with f/l optics can image features down to a size of approximately 2λ≈940 nm. For an infrared VCSEL (vertical-cavity surface-emitting laser) operating at 850 nm, the minimum feature size that may be imaged increases to 1.7 μm. Therefore, the use of blue light may permit smaller tracking features to be imaged with appropriate image sensors and optical components.

Blue light may also have a higher reflectivity than other wavelengths of light on various specific surfaces. For example, FIG. 7 shows a graph of the reflectivity of white paper with and without optical brightener across the visible spectrum. An “optical brightener” is a fluorescent dye that is added to many types of paper to make the paper appear white and “clean”. FIG. 7 shows that white paper with an optical brightener reflects relatively more in and near a blue region of a visible light spectrum than in other some other regions of the spectrum. Therefore, using light in or near a blue region of a visible light spectrum as a mouse light source may lead to synergistic effects when used on surfaces that include optical brighteners, as well as other such fluorescent or reflectively-enhanced tracking surfaces, thereby improving mouse performance on such surfaces to an even greater degree than on other surfaces.

Such effects may offer advantages in various use scenarios. For example, a common use environment for a portable mouse is a conference room. Many conference room tables are made of glass, which is generally a poor surface for optical mouse performance. To improve mouse performance on transparent surfaces such as glass, users may place a sheet of paper over the transparent surface for use as a makeshift mouse pad. Therefore, where the paper comprises an optical brightener, synergistic effects in mouse performance may be realized compared to the use of other surfaces, allowing for reduced power consumption and therefore better battery life for a battery operated mouse.

Similar synergistic effects in performance may be achieved by treating or preparing other surfaces to have brightness-enhancing properties, such as greater reflectivity, fluorescent or phosphorescent emission, etc., when exposed to light in or near a blue portion of the visible spectrum. For example, a mouse pad or other dedicated surface for mouse tracking use may comprise a brightness enhancer such as a material with high reflectivity in the blue range, and/or a material that absorbs incident light and fluoresces or phosphoresces in the blue range. When used with a blue light mouse, such a material may provide greater contrast than surfaces without such a reflective or fluorescent surface, and thereby may lead to good tracking performance, low power consumption, etc.

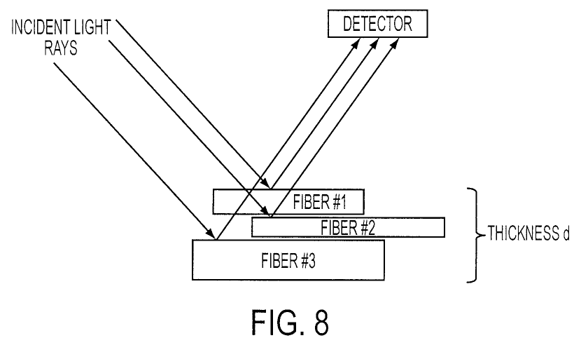

For some tracking surfaces such as paper, the use of an incoherent light source as opposed to a coherent light source may offer advantages. For example, FIG. 8 shows a simplified model of light from an optical mouse reflected from ordinary copier paper. The microscopic structure of paper is that of stacked layers of fibers with voids between some of the fibers. Long wavelength laser light can penetrate multiple layers into the surface of the paper before reflection. This is shown in FIG. 8 as the reflection of light from three different layers of fibers in the paper.

In this environment, a laser operating at 850 nm with a linewidth of approximately Δλ<0.1 nm has a coherence length of

$${L}_{c} = \frac{{λ}^{2}}{Δ λ} > \frac{{( 850 nm )}^{2}}{.007 nm} \approx 10 m .$$

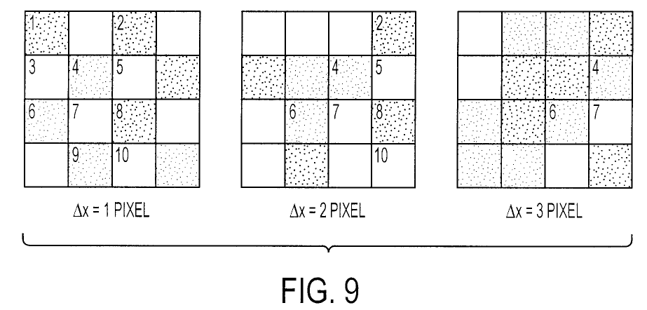

In this simplified model, each of the three incident bundles of light rays will interfere at the detector, creating an interference pattern. Extending this simple model to many more light rays spread over a large paper surface area results in a complicated interference pattern. The complicated laser interference pattern described above, caused by reflection from fibers at different depths, may create image sequences with very short correlation lengths, as shown in FIG. 9. The image content is generally high frequency, and may have a large fraction of the tracking features above the Nyquist limit of the detector. Some navigation algorithms determine mouse motion by performing a correlation calculation on the image sequence. If the features contained in the images “die away” quickly and don't persist across multiple adjacent images because they possess a short correlation length, the correlation calculation is no longer effectively able to obtain a reliable estimate of the mouse motion. Additionally, image streams with long correlation lengths are beneficial as they may allow potentially simpler algorithms than those currently used in mice. Simple algorithms and reduced computation may allow power savings and longer battery life. This may allow, for example, the employment of complicated algorithms that switch between different software filter coefficients to be avoided.

In the case of a laser mouse operating on white paper, correlation lengths may be no more than a single detector pixel (30-50 μm) in length, and consequently the tracking performance suffers. For example, referring again to FIG. 9, this figure shows an example of a 4×4 pixel sub-region of an image at the detector of a laser mouse tracking on white paper. As the mouse is moved, high frequency image features decorrelate rapidly. By the time the surface is moved 3 pixels, only 3 of the original 10 tracking features are present.

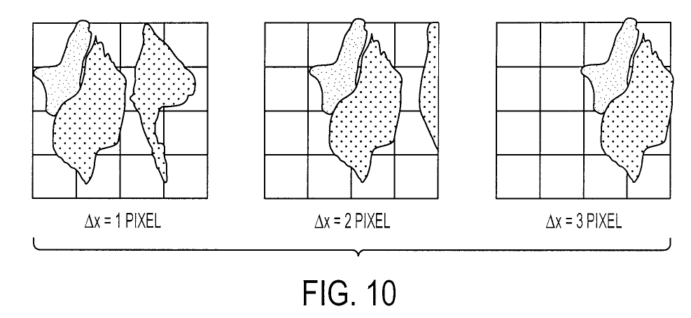

In contrast to a laser light source, a blue LED emitting light with a wavelength of 470 nm and with a line width Δλ of approximately 30 nm has a much shorter coherence length, approximately 7 μm. This shorter coherence length means that light rays reflected from paper fibers at different depths do not create interference patterns at the detector. Image correlation lengths of tens of pixels may therefore be possible through the use of a blue incoherent light source, as shown in FIG. 10. Additionally, the spatial frequencies of these features tend to be comfortably below the Nyquist limit of the detector. A correlation algorithm may be well-suited to analyze this type of image sequence possessing long correlation lengths and to extract a robust estimate of the underlying surface motion.

It will be appreciated that the use of blue coherent light may offer similar advantages over the use of red or infrared coherent light regarding speckle size. Because the speckle size is proportional to the wavelength, blue coherent light generates smaller speckles than either a red or infrared laser light source. In some laser mice embodiments it is desirable to have the smallest possible speckle, as speckle is a deleterious noise source and degrades tracking performance. A blue laser has relatively small speckle size, and hence more blue speckles will occupy the area of a given pixel than with a red or infrared laser. This may facilitate averaging away the speckle noise in the images, resulting in better tracking.

The shorter coherence length of blue light may offer other advantages as well. For example, an optical mouse utilizing blue light may be less sensitive to dust, molding defects in the system optics, and other such causes of fixed interference patterns than a laser mouse. For example, in the case of a 10 μm dust particle located on the collimating lens of a laser mouse, as the coherent laser light diffracts around the dust particle, circular rings of high contrast appear at the detector. The presence of these rings (and other such interference patterns) may cause problems in the tracking of a laser mouse, as a fixed pattern with high contrast that is presented to the detector creates an additional peak in the correlation function that is not moving. For a similar reason, the manufacturing of laser mice often requires tight process control on the quality of the injection molded plastic optics, as defects in the plastic may create deleterious fixed patterns in the image stream.

The use of blue light may help to reduce or avoid such problems with fixed patterns. When coherent light strikes a small particle such as a dust particle (wherein “small” in this instance indicates a wavelength roughly the size of the wavelength of light), the light diffracts around the particle and creates a ring-shaped interference pattern. The diameter of the center ring is given by the following relationship:

Diameter=2.44(λ)(f/#)

Therefore, according to this relationship, blue light will cause a smaller ring than red or infrared light, and the image sensor will see a smaller fixed-pattern noise source. Generally, the larger the fixed-pattern the detector sees and the more detector pixels that are temporarily unchanging, the worse the navigation becomes as the correlation calculation may become dominated by non-moving image features. Further, with incoherent light, the distances over which diffraction effects are noticeable are even shorter.

A further advantage of the blue specular imaging architecture is that it allows opto-mechanical packaging in small form-factor, low cost modules with a small z-height. Navigation devices with a short optical track length are desirable in applications such as mobile phones or designer mice with complex industrial design, where space is at a premium. Conventional red LED mice have relatively large volume packages because of the oblique illumination and shadow imaging requirement. With traditional laser mice, it is difficult to obtain a collimated laser beam, with a size that's large enough to accommodate manufacturing tolerances, in a short track length optical system because of the relatively small divergence angle of typical VCSEL laser sources. Laser mice based upon speckle physics are also problematic at small z-height because the speckle size (˜optical f/#) trades-off with the illumination at the detector (˜1/(f/#)̂2).

In light of the physical properties described above, the use of blue light may offer various advantages over the use of red light or infrared light in an optical mouse. For example, the higher reflectivity and lower penetration depth of blue light compared to red or infrared light may allow for the use of a lower intensity light source, thereby potentially increasing battery life. This may be particularly advantageous when operating a mouse on white paper with an added brightness enhancer, as the intensity of fluorescence of the brightness enhancer may be strong in the blue region of the visible spectrum. Furthermore, the shorter coherence length and smaller diffraction limit of blue light compared to red light from an optically equivalent (i.e. lenses, f-number, image sensor, etc.) light source may allow both longer image feature correlation lengths and finer surface features to be resolved, and therefore may allow a specular incoherent blue-light mouse to be used on a wider variety of surfaces. Examples of surfaces that may be used as tracking surfaces for a specular blue LED optical mouse include, but are not limited to, paper surfaces, fabric surfaces, ceramic, marble, wood, metal, granite, tile, stainless steel, and carpets including Berber and deep shag.

Further, in some embodiments, an image sensor, such as a CMOS sensor, specifically configured to have a high sensitivity (i.e. quantum yield) in the blue region of the visible spectrum may be used in combination with a blue light source. This may allow for the use of even lower-power light sources, and therefore may help to further increase battery life.

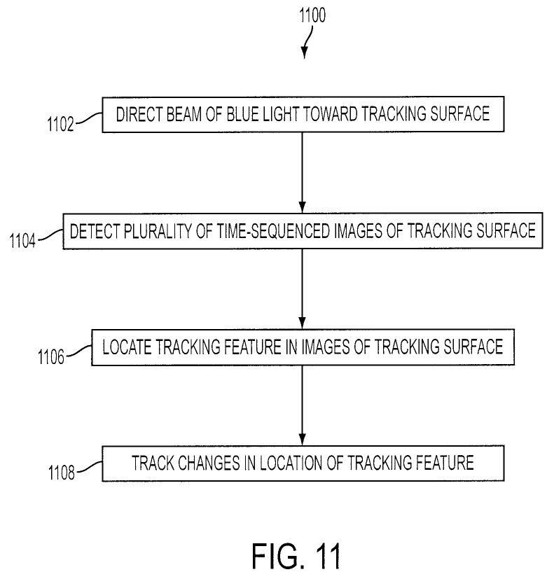

FIG. 11 shows a process flow depicting an embodiment of a method 1100 of tracking a motion of an optical mouse across a surface. Method 1100 comprises, at 1102, directing an incident beam of light emitted from a blue light source toward a tracking surface, and detecting, at 1104, a plurality of time-sequenced images of the tracking surface via an image sensor configured to detect an image of the surface at or near a specular angle of reflection. Next, method 1100 comprises, at 1106, locating a tracking feature in the plurality of time-sequenced images of the tracking surface, and then, at 1108, tracking changes in the location of the tracking feature in the plurality of images. An (x, y) signal may then be provided by the optical mouse to a computing device for use by the computing device in locating a cursor or other indicator on a display screen.

By following method 1100, motion of the optical mouse may be tracked on a broad variety of surfaces, including but not limited to paper, ceramic, metallic, fabric, carpet, and other such surfaces.

It will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. An optical mouse, comprising:
a light source configured to emit light having a wavelength in or near a blue region of a visible light spectrum toward a tracking surface;
an image sensor positioned relative to the light source such that light from a specular portion of a distribution of light from the light source and reflected by the tracking surface is detected by the image sensor; and
a controller configured to receive image data from the image sensor and to identify a tracking feature in the image data.

2. The optical mouse of claim 1, wherein the light source is configured to emit light comprising a wavelength within a range of 400 nm to 490 nm.

3. The optical mouse of claim 1, wherein the light source is configured to emit light of a wavelength that causes fluorescence or phosphorescence to be emitted by a brightness enhancer in the tracking surface.

4. The optical mouse of claim 3, wherein the light source is configured to form a beam of light having an angle of between 0 and 40 degrees with respect to the tracking surface normal.

5. The optical mouse of claim 1, wherein the image sensor is positioned to detect light in a range of 0 to +/−20 degrees with respect to a specular axis.

6. The optical mouse of claim 1, wherein the optical mouse is a portable mouse.

7. The optical mouse of claim 1, wherein the light source comprises a light-emitting diode configured to emit blue and/or white light.

8. The optical mouse of claim 1 wherein the light source comprises a laser.

9. The optical mouse of claim 1, wherein the detector is a CMOS image sensor configured to have a high sensitivity to blue light.

10. An optical mouse comprising:
a light source configured to emit light in a range of 400-490 nm toward a tracking surface at an incident angle in a range of 0 to 40 degrees relative to the tracking surface;
an image sensor positioned to detect reflected light within an angle of 0 to 20 degrees with respect to a specular axis; and
a controller configured to locate a tracking feature in a plurality of time-sequenced images of the tracking surface, and track changes in a location of the tracking feature across the plurality of time-sequenced images of the tracking surface.

11. The optical mouse of claim 10, wherein the optical mouse is a portable optical mouse.

12. The optical mouse of claim 10, wherein the light source is configured to emit coherent light.

13. The optical mouse of claim 10, wherein the light source comprises an LED or OLED configured to emit blue or white light.

14. An optical mouse comprising:
a light source configured to emit coherent light in or near a blue region of the visible spectrum toward a tracking surface;
an image sensor positioned to detect reflected light within a specular portion of a distribution of reflected light; and
a controller configured to locate a tracking feature in a plurality of time-sequenced images of the tracking surface, and track changes in a location of the tracking feature across the plurality of time-sequenced images of the tracking surface.

15. The optical mouse of claim 14, wherein the mouse is a portable battery-powered mouse.

16. The optical mouse of claim 14, wherein the light source is configured to emit light comprising a wavelength in a range of 400 nm to 490 nm.

17. An optical mouse comprising:
a light source configured to emit incoherent light comprising wavelengths in or near a blue region of the visible spectrum toward a tracking surface;
an image sensor positioned to detect reflected light within a specular portion of a distribution of reflected light; and
a controller configured to locate a tracking feature in a plurality of time-sequenced images of the tracking surface, and track changes in a location of the tracking feature across the plurality of time-sequenced images of the tracking surface.

18. The optical mouse of claim 17, wherein the light source is configured to emit blue light.

19. The optical mouse of claim 17, wherein the light source is configured to emit white light.

20. The optical mouse of claim 17, wherein the light source is an LED.

21. The optical mouse of claim 17, wherein the light source is an OLED.

22. A method of tracking motion of an optical mouse, comprising:
directing an incident beam of light having a wavelength in or near a blue region of a visible light spectrum toward a tracking surface comprising an optical brightener;
detecting a plurality of time-sequenced images of the tracking surface with an image sensor by detecting light emitted by the optical brightener in response to the incident beam of light;
locating a tracking feature in the plurality of time-sequenced images of the tracking surface; and
tracking changes in location of the tracking feature across the plurality of time-sequenced images of the tracking surface.

23. The method of claim 22, wherein directing an incident beam of light toward a tracking surface comprises directing the incident beam of light toward a sheet of paper comprising a brightness enhancer.

24. The method of claim 22, wherein directing an incident beam of light toward the tracking surface comprises directing an incident beam of light with a wavelength in a range of 400 to 490 nm.

25. The method of claim 22, wherein detecting a plurality of time-sequenced images of the tracking surface comprises detecting light reflected from the surface at an angle in a range of 0 to +/−20 degrees from a specular axis, and wherein directing the incident beam of light toward the tracking surface comprises directing the incident beam of light toward the tracking surface at an angle in a range of 0 to 40 degrees with respect to a tracking surface normal.
